(19) United States
(12) Patent Application Publication
(10) Pub. No.: US 2013/0192768 A1
(43) Pub. Date: Aug. 1, 2013

(54) STRUCTURE OF TIRE CHANGER

(71) Applicant: CHIH-LIANG PENG, New Taipei City (TW)

(72) Inventor: CHIH-LIANG PENG, New Taipei City (TW)

(21) Appl. No.: 13/361,954

(22) Filed: Jan. 31, 2012

(51) Int. Cl. B60C 25/138

(52) U.S. Cl. 157/1.22

(57) ABSTRACT

A tire changer is provided for mounting/dismounting a tire to/from a wheel rim. The tire changer includes a tire fixing device mounted to a support arm and including a transmission cylinder that is rotatably mounted to the support arm and driven by a power device, a first retention member, a second retention member, and a fastening member. The transmission cylinder receives therein a transmission shaft having an end projecting outside the cylinder and forming a fastening section. The first and second retention members are mounted to the transmission shaft and both form a slope that is set in abutting engagement with an inside surface of a fixing bore formed in the rim. The fastening member is coupled to the fastening section to be positioned against the second retention member to thereby secure the rim between the first and second retention members.

### TECHNICAL FIELD OF THE INVENTION

The present invention generally relates to a machine or device for mounting/dismounting and inspection of tires, and more particularly to an improved structure of tire changer that is durable and easy to use and is fit to various types of wheel rim.

### DESCRIPTION OF THE PRIOR ART

After the Industrial Revolution, rubber tires 21 gradually became the main stream in the market of tires 21. The tires 21 play an important role for both transportations and operation machines. However, after a tire 21 gets broken, the operation of mounting/dismounting the tire 21 and rim 20 is quite time consuming. To overcome such a problem, tire changers are available in the market to dismounting and mounting tires 21 and rims 20. For example, Taiwan Patent Application No. 078200998 discloses a horizontal tire changer. FIG. 1 of the attached drawings shows the conventional horizontal tire changers in an assembled form, in which a chuck 9 and a bead loosening bar 5 are used as a structure for dismounting/mounting a tire 21 from/to a rim 20. Although this conventional device is an excellent device, yet it suffers certain problems that must be further improved.

For example, the chuck 9 is constructed such that the chuck 9 comprises four clamps that are expandable outward to achieve the purpose of fixing. However, such a chuck 90 operates with a slow speed and a substantial time must be wasted before the fixing is secured. Further, the distance that the chuck 9 may expand outward is limited. When a central fixing bore 22 of the rim 20 is greater than the available expansion distance that the chuck 9 may make, such a horizontal tire changer cannot be used to change tire for such a rim.

Further, the chuck 9 is composed of welded parts. Humidity of the surroundings and the heavy load that the tire 21 and the rim 20 of a heavy-duty vehicle apply to the chuck 9 may disadvantageously lead to unexpected breaking of the chuck 9 during the operation thereof and undesired dangerous situation may happen. Further, other components of the tire changer, such as a transmission cylinder 711 and a shaft 712, are components that are secured by bolts. The transmission cylinder 711 and the shaft 712 must take the weight of the structure of the chuck 9 and also the weights of the tire 20 and the rim 21. All these weights, together with other factors, such as aging and weather, may lead to unexpected breaking or damages of the bolts and the components secured thereby. This certainly shortens the lifespan of the tire changer and may undesirably lead to risk of the operators.

### SUMMARY OF THE INVENTION

The primary objective of the present invention is to provide a breakthrough of the problems of the conventional horizontal tire changer that the expansion distance of the chuck is limited, making it impossible to fit to rims having fixing bores of various sizes, so that the present invention provides an improvement of being applicable to various types of rim.

To achieve the above objective, the present invention provides an improved structure of tire changer, which is used to mount/dismount a tire to/from a wheel rim that forms at least one fixing bore. The tire changer comprises a base on which a control section, a bead loosening bar, and a support arm are disposed and a tire fixing device is rotatably mounted to the support arm. The tire fixing device comprises a transmission cylinder, which forms a shaft. The shaft is driven by a power device mounted to the support arm. The shaft is rotatably mounted to the support arm. The transmission cylinder receives therein a transmission shaft that projects outside the transmission cylinder. The projecting end of the transmission shaft forms a fastening section. A first retention member forms, in a center position, a first shaft bore that receives the transmission shaft therethrough and the first retention member is fixed to a portion of the transmission cylinder that is away from the support arm. The first retention member has a circumference forming a first slope. The first slope is set in abutting engagement with an inside surface of the fixing bore. The first retention member forms a reduced end inside the fixing bore. A second retention member forms, in a center position, a second shaft bore that receives the transmission shaft therethrough. The second retention member has a circumference forming a second slope. The second slope is set in abutting engagement with a wall surface of the fixing bore. The second retention member forms a reduced end inside the fixing bore, or the second retention member forms a plurality of coupling sections that is respectively received into and coupled to fixing bores. A fastening member is positioned against the second retention member. The fastening member is coupled to the fastening section. The fastening member and the fastening section are coupled through threading engagement, or alternatively, the fastening member forms a fixing slot and the fastening section forms a fixing tenon corresponding to the fixing slot to allow the fastening member and the fastening section to be coupled by the fixing tenon. As such, when the fastening member is fixed to the fastening section, by having the transmission shaft withdrawn back into the transmission cylinder, the fastening member that is coupled to the fastening section and positioned against the second retention member forces the first slope and the second slope to respectively and tightly engage the two ends of the fixing bore, thereby realizing the purpose of fixing the rim and the tire to the tire fixing device.

With the above described arrangement, the problems of the conventional horizontal tire changer that has a slow speed of operation for fixing and a substantial time is needed for waiting are overcome and thus a practical improvement of easy fixing can be realized.

Another objective of the present invention is to overcome the problem of the conventional horizontal tire changer that the chuck, the transmission cylinder, and the shaft are all components composed of several parts coupled together and may be easily broken to thereby reduce the lifespan and cause dangers, in order to achieve a practical improvement of enhanced durability.

To achieve the objective, according to the present invention, a transmission cylinder and a shaft are integrally formed through lathing and are made of high strength metals, such as steel, aluminum alloy, and titanium alloy. Further, the transmission cylinder receives therein a transmission shaft that has an end projecting outside the transmission cylinder and the projecting end of the transmission shaft forms a fastening section. The transmission shaft is received in a first shaft bore defined in a center position of the first retention member. The first retention member is mounted to a portion of the transmission cylinder that is away from the support arm. The first retention member has a circumference forming a first slope, which is in abutting engagement with engagement with an inside surface of the fixing bore. The first retention member forms a reduced end inside the fixing bore. The transmission shaft is also received through a second shaft bore defined in a center of a second retention member. The second retention member has a circumference forming the second slope. The second slope is set in abutting engagement with a wall surface of the fixing bore. The second retention member forms a reduced end inside the fixing bore, or the second retention member forms a plurality of coupling sections that is respectively received into and coupled to fixing bores. A fastening member is positioned against the second retention member. The fastening member is coupled to the fastening section. This arrangement is provided to replace the conventional chuck that is a welded structure.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a conventional horizontal tire changer.

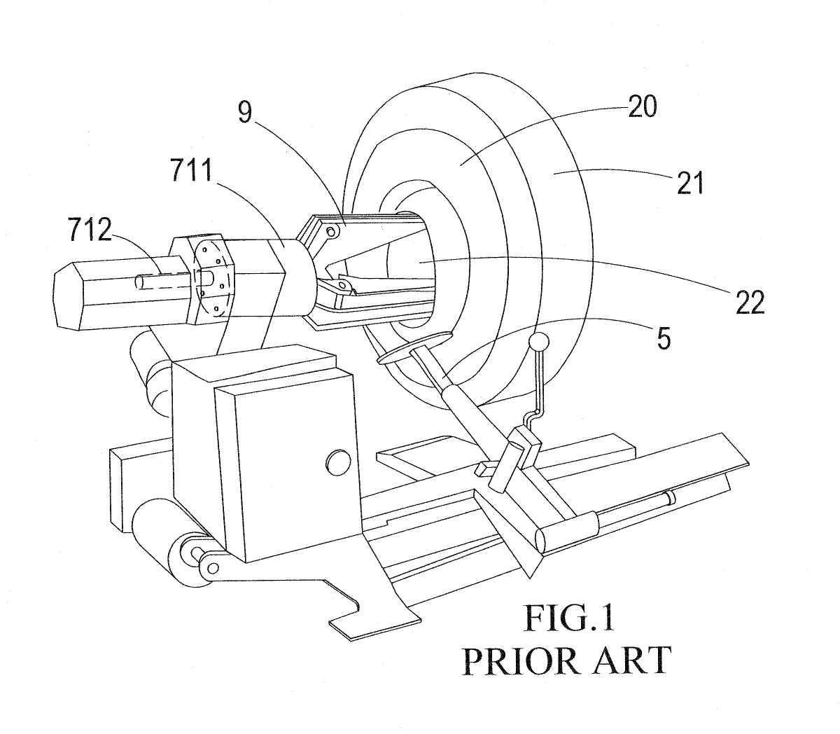

FIG. 2 is a perspective view showing a preferred embodiment of the present invention.

FIG. 3 is a cross-sectional view of the preferred embodiment of the present invention.

FIG. 4 is an enlarged cross-sectional view of a portion of the preferred embodiment of the present invention.

FIG. 5 is a cross-sectional view showing another preferred embodiment of the present invention.

FIG. 6 is a schematic view showing a further preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

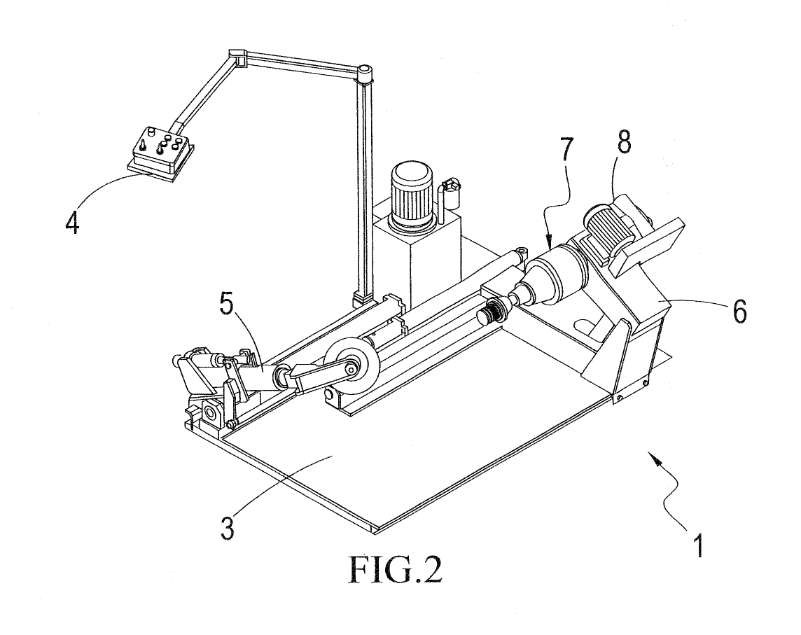

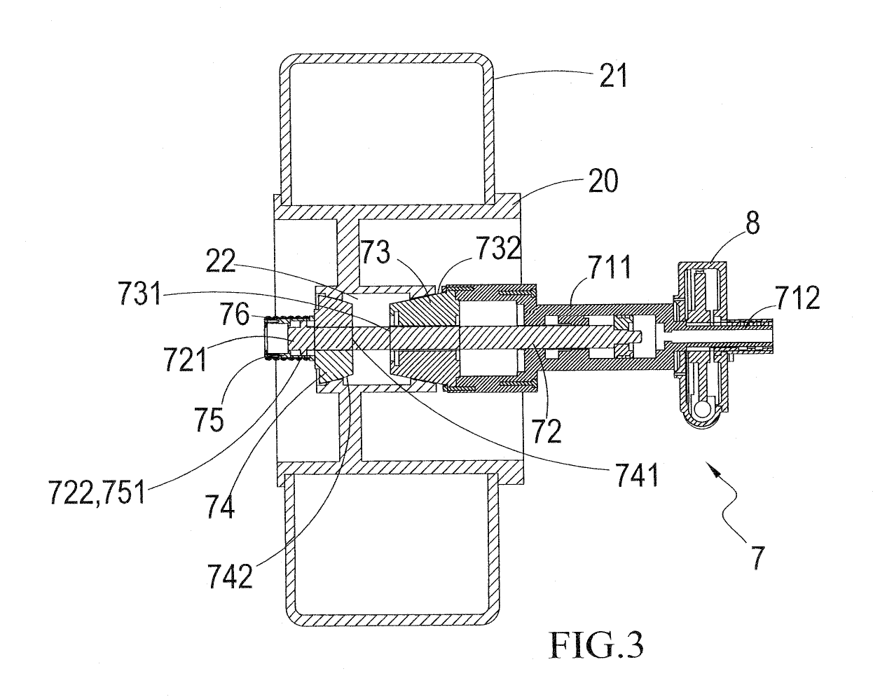

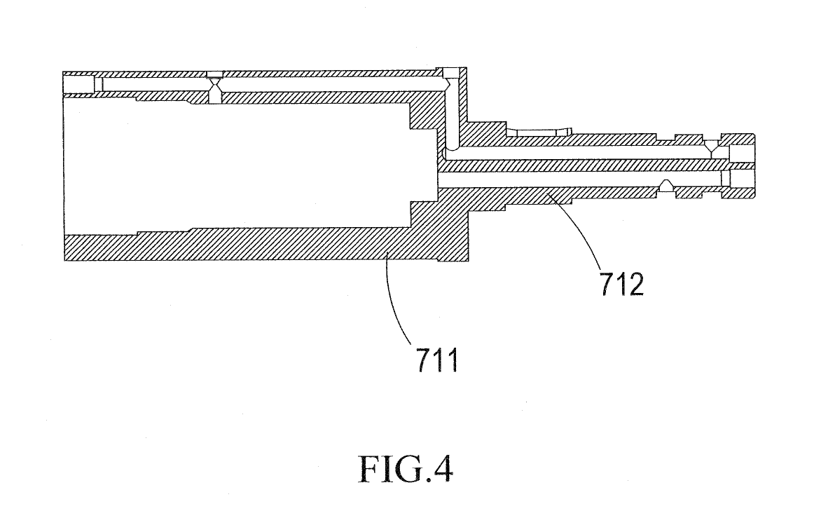

Referring to FIGS. 2, 3, and 4, of which FIG. 2 is a perspective view in an assembled form, FIG. 3 is a cross-sectional view, and FIG. 4 a partial cross-sectional view, these drawings clearly show that the present invention provides an improved structure of a tire changer 1. The tire changer 1 is used to dismount/mount a tire 21 from/to a rim 20, in which the rim 20 forms at least one fixing bore 22. The general structure of the tire changer 1 comprises a base 3 on which a control section 4, a bead loosening bar 5, and a support arm 6 are disposed. A tire fixing device 7 is rotatably mounted to the support arm 6. The tire fixing device 7 comprises a transmission cylinder 711, and the transmission cylinder 711 forms a shaft 712. The shaft 712 is driven by a power device 8 mounted to the support arm 6. The shaft 712 is rotatably mounted to the support arm 6. The transmission cylinder 711 receives therein a transmission shaft 72 that projects outside the transmission cylinder 711. The projecting end of the transmission shaft 72 forms a fastening section 721. A first retention member 73 is fixed to a portion of the transmission cylinder 711 that is away from the support arm 6. The first retention member 73 forms, in a center position, a first shaft bore 731 that receives the transmission shaft 72 therethrough. The first retention member 73 has a circumference forming a first slope 732. The first slope 732 is set in abutting engagement with an inside surface of the fixing bore 22. The first retention member 73 forms a reduced end inside the fixing bore 22. A second retention member 74 forms, in a center position, a second shaft bore 741. The second shaft bore 741 is fit over the transmission shaft 72. The second retention member 74 has a circumference forming a second slope 742. The second slope 742 is set in abutting engagement with the inside surface of the fixing bore 22. The second retention member 74 forms a reduced end inside the fixing bore 22. A fastening member 75 is positioned against the second retention member 74. The fastening member 75 is coupled to the fastening section 721. The fastening member 75 has an outer circumference over which a grip sheath 76 is fit. The fastening member 75 forms a fixing slot 751, and the fastening section 721 forms a fixing tenon 722 corresponding to the fixing slot 751 to allow the fastening member 75 and the fastening section 721 to be secured by the fixing tenon 722.

With the above described arrangement, the operation of the present invention will be described. Reference is now made to FIGS. 2, 3, and 4, of which FIG. 2 is a perspective view in an assembled form, FIG. 3 is a cross-sectional view, and FIG. 4 a partial cross-sectional view, these drawings clearly show that the transmission cylinder 711 forms the shaft 712 and the shaft 712 is driven by the power device 8 mounted to the support arm 6. The shaft 712 is rotatably mounted to the support arm 6. Thus, as being driven by the power device 8, the tire fixing device 7 causes the shaft 712 to rotate. Since the transmission cylinder 711 and the shaft 712 are integrated with each other, the structure is strengthened and the lifespan is extended.

Further, the transmission cylinder 711 comprises the transmission shaft 72 that projects outside the transmission cylinder 711 mounted therein. The outward projecting end of the transmission shaft 72 forms the fastening section 721. The transmission shaft 72 is received through the first shaft bore 731 defined in the center of the first retention member 73. The first retention member 73 is fixed to the portion of the transmission cylinder 711 that is away from the support arm 6 and the first retention member 73 has a circumference forming the first slope 732. The first slope 732 is set in abutting engagement with the inside surface of the fixing bore 22. The first retention member 73 forms a reduced end inside the fixing bore 22. The transmission shaft 72 is also received through the second shaft bore 741 defined in the center of the second retention member 74. The second retention member 74 has a circumference forming the second slope 742. The second slope 742 is set in abutting engagement with the inside surface of the fixing bore 22. The second retention member 74 forms a reduced end inside the fixing bore 22. The fastening member 75 is positioned against the second retention member 74. The fastening member 75 is coupled to the fastening section 721. As such, by having the transmission shaft 72 withdrawn back into the transmission cylinder 711, the fastening member 75 that is coupled to the fastening section 721 and positioned against the second retention member 74 forces the first slope 732 and the second slope 742 to respectively and tightly engage the two ends of the fixing bore 22, thereby realizing the purpose of fixing the rim 20 and the tire 21 to the tire fixing device 7. Since the first slope 732 and the second slope 742 are engageable with the inside surface of the fixing bore 22 that may be of different dimension, they can be used to fix rims 20 having different fixing bores 22 without change or adjust any components When a rim 20 having an even larger fixing bore 22 is needed, only the first retention member 73 and the second retention member 74 need to be replaced and it is not necessary to replace the whole device, this being an advantage of economic value. Since the structure of the present invention is formed of a combination of the transmission cylinder 711, the transmission shaft 72, the first retention member 73, and the second retention member 74, so that as compared to the conventionally used welded chuck 9, the present invention can has a strengthened structure and extended lifespan.

Further, the grip sheath 76 is fit over the fastening member 75. The fastening member 75 defines the fixing slot 751, and the fastening section 721 forms the fixing tenon 722 corresponding to the fixing slot 751, so that the fastening member 75 and the fastening section 721 are secured by the fixing tenon 722. By having the transmission shaft 72 withdrawn back into the transmission cylinder 711, the first slope 732 of the first retention member 73 and the second slope 742 of the second retention member 74 are brought into tight engagement with the inside surface of the fixing bore 22, so that the rim 20 can be fixed in an efficient and time- and effort-reduced manner.

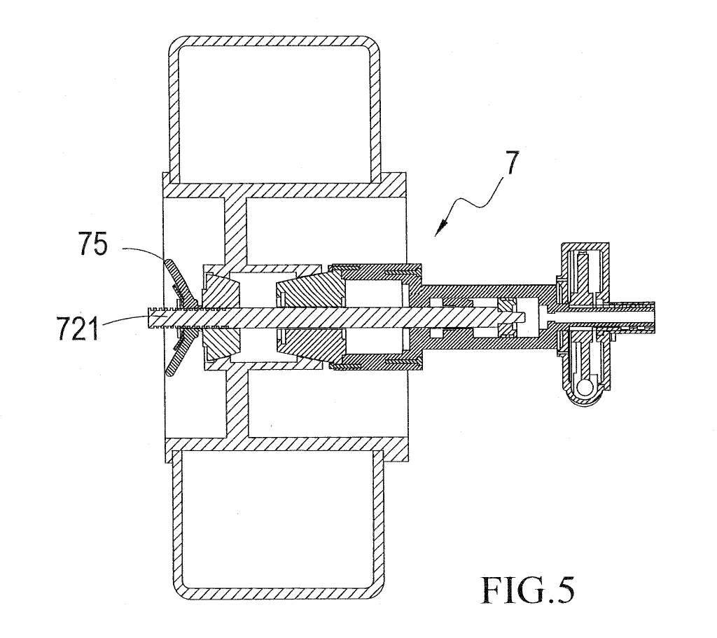

The structure and operation of another embodiment of the present invention are described below. Referring to the cross-sectional view shown in FIG. 5, the drawing clearly shows that the fastening member 75 and the fastening section 721 are coupled through threading engagement. With such a structure, the tightness of the tire fixing device 7 can be adjusted through minute thread-based distance adjustment of the fastening member 75.

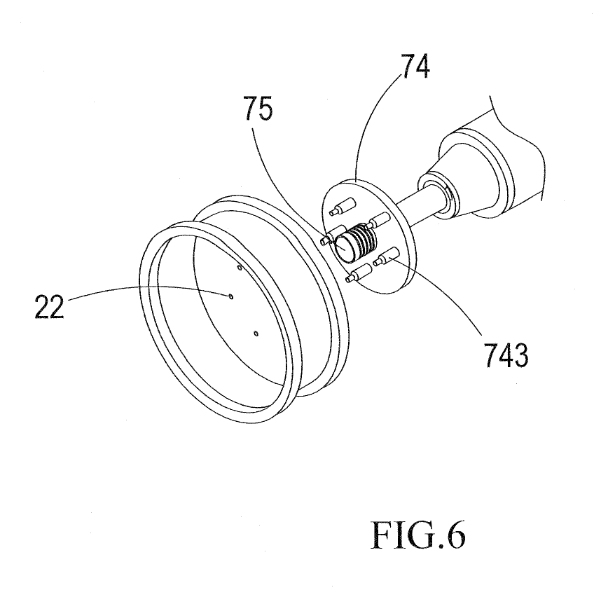

The operation of a further embodiment of the present invention is described below. Referring to the perspective view shown in FIG. 6, the drawing clearly shows that the second retention member 74 forms a plurality of coupling sections 743 adjacent to the fastening member 75 and the coupling sections 743 are respectively received in and coupled to fixing bores 22. When the central fixing bore 22 is excessively large so that it cannot be fixed by the second retention member 74 discussed in the previous embodiments, fixing can be done by having the coupling sections 743 fit into and coupled to the circumferential fixing bores 22. Further, some wheel rims 20 are of a design that is free of the central fixing bore 22, and for such wheel rims, the conventional chuck 9 will be completely useless. However, according to the present invention, it only needs to switch to the second retention member 74 illustrated in the instant embodiment to effect fixing.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A tire changer, which is adapted to mount/dismount a tire to/from a rim that forms at least one fixing bore, the tire changer comprising a base on which a control section, a bead loosening bar, and a support arm are mounted, a tire fixing device being rotatably mounted to the support arm, characterized in that the tire fixing device comprise:
a transmission cylinder, which forms a shaft, the shaft being rotatably mounted to the support arm, the transmission cylinder receiving therein a transmission shaft that has an end projecting outside the transmission cylinder, the projecting end of the transmission shaft forming a fastening section;
a first retention member, which is fixed to a portion of the transmission cylinder that is away from the support arm, the first retention member forming, in a center position, a first shaft bore into which the transmission shaft is received;
a second retention member, which forms, in a center position, a second shaft bore into which the transmission shaft is received; and
a fastening member, which is positioned against the second retention member, the fastening member being coupled to the fastening section.

2. The tire changer according to claim 1, wherein the first retention member has a circumference forming a first slope, which is engageable with an inside surface of the fixing bore, the first retention member forming a reduced end inside the fixing bore.

3. The tire changer according to claim 1, wherein the second retention member has a circumference forming a second slope, which is engageable with a wall surface of the fixing bore, the second retention member forming a reduced end inside the fixing bore.

4. The tire changer according to claim 1, wherein the second retention member forms a plurality of coupling sections adjacent to the fastening member, the coupling sections being receivable in and coupled to fixing bores.

5. The tire changer according to claim 1, wherein the fastening member and the fastening section are coupled by a tenon-slot arrangement.

6. The tire changer according to claim 5, wherein the fastening member forms a fixing slot, the fastening section forming a fixing tenon corresponding to the fixing slot.

7. The tire changer according to claim 1, wherein the fastening member and the fastening section are coupled by threading engagement.

8. The tire changer according to claim 1, wherein the fastening member is coupled to and enclosed by a grip sheath.

9. The tire changer according to claim 1, wherein the support arm comprises a power device mounted thereto to drive the shaft.
